(19) United States
(12) Patent Application Publication
(10) Pub. No.: US 2019/0224990 A1
(43) Pub. Date: Jul. 25, 2019

(54) PROCESS FOR PREPARING DECORATIVE FIRED SUBSTRATE

(71) Applicant: Electronics for Imaging, Inc., Fremont, CA (US)

(72) Inventors: David Weber, Middleton, WI (US); Mark Zavada, Wixom, MI (US); Louis Justus Fage, Redford, MI (US); Ursula Good, Jackson, MI (US); Robert Roggers, Ypsilanti, MI (US); Alexander Meranto, Ferndale, MI (US); Matthew Tennis, Fenton, MI (US); Paul Edwards, Kalamazoo, MI (US)

(21) Appl. No.: 15/876,075

(22) Filed: Jan. 19, 2018

(51) Int. Cl. B41J 11/00; C09D 11/54; C09D 11/322; C04B 41/89; B41J 2/04

(52) U.S. Cl. CPC B41J 11/002; C09D 11/54; B41J 2/04; C04B 41/89; C09D 11/322

(57) ABSTRACT

The present invention relates to a process for preparing a decorative fired substrate such as ceramic, glass, brick, metal or metal enamel. The process includes a step of digitally applying a primer ink composition comprising a metal or metalloid ion component dissolved in a liquid matrix on selective locations of the substrate. The primer ink composition can be applied before or after the application of a color ink. By applying a primer ink composition, the color of the substrate is improved after the substrate is fired, and the manufacture cost is reduced compared with current industrial decorative ceramic tile processes.

### FIELD OF THE INVENTION

The present invention relates to a process for preparing a decorative fired substrate such as ceramic tiles. The process includes a step of digitally applying a primer ink composition comprising a metal ion component dissolved in a liquid matrix on selective locations of the substrate.

### BACKGROUND OF THE INVENTION

Most traditional ceramic manufactured products, such as wall tiles and floor tiles, are made of a ceramic body that confers form and mechanical properties to the object; the ceramic body generally has some porosity and poor aesthetic qualities. Said ceramic body, which is defined “green” or, alternatively, “bisque”, if previously fired, is then usually coated with a ceramic layer (ceramic glaze); the ceramic glaze is completely sintered by firing, in such a way to gain suitable superficial aesthetic qualities and, in the meantime, to become a fluid-proof barrier; as a matter of fact, after firing, the ceramic glaze has usually no porosity and is generally resistant to abrasion and to the attack of chemical agents such as acids, bases, dyes.

The aesthetic finishing of the ceramic material can be completed by a decoration phase, that is by the application of colored ceramic materials (ceramic pigments) which are applied according to a precise decorative drawing.

The industrial decorative ceramic tile process often incorporates the following basic steps. (1) Form the ceramic tile body from powdered raw materials in a hydraulic press. (2) Apply at least one glaze layer top coat to the tile, which provides the visual and textural properties of the decorative ceramic tile. Glaze layers are typically applied using analog methods, such as waterfall or spray gun techniques. (3) Use pigmented ceramic inks to apply a decorative image on the glaze layer by digital inkjet or analog (screen print, rollers, etc) methods. (4) Fire decorative glaze ceramic tile in a high temperature ceramic kiln.

An alternative to ceramic tile process described above incorporates the following steps. (1) Form the ceramic tile body from powdered raw materials in a hydraulic press. (2) Use metal salt dye inks to apply a decorative image on the ceramic tile body surface by digital inkjet or analog (screen print, rollers, etc.) methods. (3) Apply solvents that are compatible with the metal dyes to the tile body surface to penetrate the dye into the tile body. (4) Fire decorative ceramic tile in a high temperature ceramic kiln. (5) Buff the surface of the tile to remove surface defects and produce a uniform and high gloss surface. The decorative image is not compromised because the solvents penetrated the dyes into the tile. In the field of decorative ceramic tile, this process is called “soluble salts.”

Due to the high temperatures involved in the ceramic tile firing process, pigment/dye color development on a ceramic tile depends on the pigment/dye and ceramic tile substrate elemental compositions.

For example, typical red brown ceramic pigments based on Zn, Fe and Cr metals will develop more intense and desirable colors after firing on glazes with higher Zn contents than glazes without Zn. This occurs even though Zn²⁺, which is the most stable oxidation state for Zn, is colorless. In this case, Zn is an essential element added to the bulk glaze material to aid in the pigment color development.

Essential elements, such as Zn, are mixed into the bulk glaze material prior to the application of the glaze layer. This ensures that the essential elements are evenly distributed within the glaze layer for uniform color development. However, these essential elements such as Zn are generally more expensive than other ceramic tile raw material components, such as mined clays, feldspars and silica. Due to this increase in raw material cost, glazed regions where ink is not applied is a waste of essential elements for the tile manufacturer.

There is a need for tile manufacturers in reducing the use of essential elements in a bulk glaze layer without sacrificing color after firing.

### BRIEF DESCRIPTION OF THE DRAWING

This application contains at least one drawings executed in color. Copies of this patent or patent application publication with color drawings will be provided by the Office upon request and payment of the necessary fee.

FIG. 1 shows the process of applying the primer inks and green color ink to a tile, and the results of the fired tile.

FIG. 2 shows a real unfired tile that followed the steps as described in FIG. 1 using a sodium antimony tartrate primer ink, titanium(IV) bis(ammoniumlactato) dihydroxide primer ink, and chromium(III) acetate, basic green color ink.

FIG. 3 shows the same tile from FIG. 2 after firing in a ceramic kiln for 1 hour at 1200° C.

### DETAILED DESCRIPTION OF THE INVENTION

The inventors have discovered that by digitally applying a base coat composition (a primer ink composition) to a substrate, the primer ink composition improves the color of a decorative substrate after thermal treatment (firing). The primer ink composition of the present invention comprises essential elements that aid the pigment or dye color development. The primer ink composition is applied in exact amounts to the selected locations on the substrate by digital printing, which reduces the cost of completely applying the essential elements on the substrate.

The present invention is directed to a process for preparing a decorative fired substrate, such as ceramic, glass, brick, metal, and metal enamel. One preferred substrate is a ceramic tile. The present process comprising the steps of: (a) digitally applying a primer ink composition on the surface of one or more selected locations of a substrate (e.g., a ceramic tile body) by a first digital inkjet printer to form a primer layer on the selected locations, wherein the primer composition comprises a colorless metal or metalloid ion component dissolved in a first liquid matrix, (b) digitally applying a color ink composition on the selected locations by a second digital inkjet printer or printbar, wherein the ink composition comprises a color metal or metalloid ion component dissolved or dispersed in a second liquid matrix, and then (c) firing the substrate in a high temperature kiln. The printing steps (a) and (b) occur before the substrate is fired in a ceramic kiln, which typically reach a high temperature up to 1300° C. The color benefits of the primer ink are only seen after the kiln firing process.

In one embodiment of the present process, the primer ink composition is applied before the color ink composition, i.e., step (a) is applied before step (b).

In another embodiment of the present process, the color ink composition is applied before the primer ink composition, i.e., step (b) is applied before step (a).

Optionally, one or more glaze layers can be applied to the substrate before the substrate is fired. The glaze layer provides the visual and textural properties of the substrate. Glaze layers are typically applied using analog methods, such as waterfall or spray gun techniques. Particle size of glaze material may be reduced via ball milling to a size close to, but greater than, 1μ to allow application.

In a first embodiment, the present process comprises the steps in the order of: (a) digitally applying a primer ink composition on the surface of one or more selected locations of a substrate by a first digital inkjet printer to form a primer layer on the selected locations, wherein the primer composition comprises a colorless or nearly colorless metal or a metalloid ion component dissolved in a first liquid matrix, (b) digitally applying a color ink composition on top of the primer layer on the selected locations by a second digital inkjet printer or printbar, wherein the ink composition comprises color metal or metalloid components dispersed or dissolved in a second liquid matrix, and then (c) firing the substrate in a high temperature kiln. The process optionally comprises an additional step prior to step (a), i.e., applying a glaze layer on top of the substrate prior to step (a), and then the primer ink composition is applied on the selected location on the glaze layer. The process optionally comprises an additional step prior to (c), i.e., applying a solvent matrix compatible with the primer ink using digital or analog methods, such as waterfall or spray gun techniques, to carry the primer ink essential elements into the tile body.

In a second embodiment, the present process comprising the steps in the order of: (a) digitally applying a color ink composition on one or more selected locations of a substrate by a first digital inkjet printer or printbar to form a color ink layer on the selected locations, wherein the color ink composition comprises color metal or metalloid dispersed or dissolved in a first liquid matrix, (b) digitally applying a primer ink composition on top the selected locations of the color layer by a second digital inkjet printer, wherein the primer ink composition comprises a colorless or nearly colorless metal or metalloid ion component dissolved in a second liquid matrix, and (c) firing the substrate in a high temperature kiln. The process optionally comprises an additional step prior to step (a), i.e., applying a glaze layer on top of the substrate prior to step (a), then the color ink composition is applied on the selected location on the glaze layer. The process optionally comprises an additional step prior to (c), i.e., applying a solvent matrix compatible with the primer ink using digital or analog methods, such as waterfall or spray gun techniques, to carry the primer ink essential elements into the tile body.

The present process uses an inkjet printer to apply digitally the primer ink composition and the color ink composition on the substrate. Digital printing refers to any printing process in which a computer controlled inkjet printer or computer controlled laser printer are used for printing any type of material. The present process does not use analog printing, which refers to a printing process in which manually prepared screens/plates are used for printing any type of material. The present process uses digital inkjet ink technology over traditional analog printing methods; the digital inkjet ink technology provides the ability to change a printed pattern by simply loading a new digital image file into the printer; the printed images are derived from a digital design. The primer ink is printed only in required quantities and specific locations as required by the design. The present process does not add essential elements (metal or metalloid ion components) in a base glaze composition, thus reducing the cost of applying a glaze composition including essential elements over the entire substrate.

In the present process, the primary functional component are metal or metalloid ions, which are selected from the group consisting of: aluminum, antimony, barium, bismuth, boron, calcium, lithium, magnesium, potassium, sodium, strontium, tin, titanium, tungsten, zinc, zirconium, gallium, germanium, indium, manganese, cadmium, selenium, lanthanum, cerium, praseodymium, neodymium, samarium, europium, gadolinium, terbium, holmium, erbium, thulium, ytterbium, lutetium, and any combination thereof. The metal ion component is 0.1-70% w/w, 1-60% w/w, 10-60% w/w, or 20-50% w/w of the primer ink composition.

In the present process, the metal or metalloid ion component is dissolved in a liquid matrix. In one embodiment, the metal or metalloid ion component is present in the form of an acetate, alkoxide, alkyl, amide, amidinate, antimonate, azide, β-diketonate, borate, carbamate, carbonyl, carboxylate, cyanide, cyclopentadienide, guanidate, hydroxide, imidazolate, lactate, manganate, molybdate, nitrate, nitride, oxide, phosphate, phosphite, phosphonate, pyrazolate, selenate, silicate, stannate, sulfate, tartrate, thiocarboxylate, dithiocarboxylate, thiolate, or tungstate, or any combination thereof. For example, the metal ion component is zinc acetate, calcium lactate, sodium/potassium antimony tartrate or titanium(IV) bis(ammonium lactate) dihydroxide.

Metal or metalloid ions that are used as an essential element of a digital primer ink composition of the present invention have different forms and the functions. In one function, metal or metalloid ions are used as pigment/dye complement. In the form of a dissolved solute, a colorless essential element, e.g., antimony, calcium, tin, titanium, tungsten, zinc, and zirconium, may enhance the properties of a pigment or dye, which is distinguishable from functioning as a standard pigment or dye.

In another function, metal or metalloid ions in the primer ink composition of the present invention are used for altering surface properties. In the form of a dissolved solute, an essential element, e.g., aluminum, antimony, barium/strontium, bismuth, boron, calcium, lithium/sodium/potassium, magnesium, tin, titanium, zinc, and zirconium may alter the surface properties such as gloss, opacity, roughness, or and texture, of the substrate.

The following are examples of functions provided by the metal or metalloid ions as an essential element in the primer ink composition for all fired applications. Aluminum can act as an opacifier and/or as a refractory material that reduces surface gloss. Antimony can stabilize yellow and brown titanate pigment colors and/or as an opacifier. Barium can blue shift colors from copper. Bismuth can act as a strong flux and form stable alloys with copper. Boron, a metalloid, can increase the surface gloss in low temperature fired applications and/or as a flux material. Calcium can stabilize pink inorganic pigments (Ca—Cr—Sn sphene pigments), act as an opacifier, and/or act as a flux to enhance the surface gloss in high temperature fired applications. Lithium/sodium/potassium can act as a flux material and/or adjust the coefficient of expansion. Magnesium can act as a matting agent and/or lowers the coefficient of expansion. Tin can stabilize pink inorganic pigments (Ca—Cr—Sn sphene pigments) and/or as an opacifier in some fired applications. Titanium can stabilize titanate-based pigments and colors, act as an opacifier, and/or variegate surface features. Tungsten can stabilize yellow and brown titanate pigment colors. Zinc can counteract calcium to increase the intensity of red-brown inorganic pigments (Zn—Fe—Cr spinel pigments, PBr 33) and/or maintain the neutral shade of black inorganic pigments (Co—Mn—Fe—Cr spinel pigments, PBk 27), and/or enhance the surface gloss. Zirconium can stabilize pigments and colors, act as an opacifier, and/or act as a refractory material.

The primer ink composition of the present invention comprises a metal or metalloid ion component dissolved in a liquid matrix. The solvent of the carrier fluid is a primary fluid component for the primer ink composition. Examples of solvent include aqueous solvent and organic solvent such as water, glycols, glycol ethers, fatty acid esters, ketones, esters, amides, paraffinic distillates, acrylates, etc.

The primer ink composition may further comprise 0.01-50%, 0.1-10%, 0.1-50%, 1-10%, or 1-50% (w/w) of one or more additive materials selected from the group consisting of: anti-settling agents, surfactants, leveling additives, pH buffer, and defoaming agents. Anti-settling agents are used to disperse solids and to maintain a stable state of the dispersion. Anti-settling agents include polymeric dispersants, hyperdispersants, phosphate derivatives, sulfate derivatives, silanes, monomeric surfactants, processed clays, etc. Examples of suitable dispersion agents include, but are not limited to, those under the designations of Lamberti FLUIJET 16930, Solsperse 32000 from Lubrizol® Advanced Materials, and DisperBYK 111 and DisperBYK180 from Byk Chemi®.

Surfactants are used to reduce the surface tension of the primer ink composition and to improve wetting property of the inks on substrates. The amount of surfactant in the ink compositions is 0.01-5% by weight, and preferably 0.05-0.5% by weight. Examples of a suitable surfactant include, but are not limited to, those under the designations of TEGORAD 2200N, TEGORAD 2100, and TEGORAD 2300 from Goldschmidt Chemical Corporation (Hopewell, Va.); and BYK 307, BYK 330, BYK 348, BYK 377 and BYK 3510 (BYK CHEMIE GMBH (Wesel, FRG).

Leveling additives may be used to improve the flowing property of ink and to produce a more uniform surface of ink film. The amount of leveling agent in the ink compositions is 0.1-5% by weight. Examples of suitable leveling agent include, but are not limited to, those under the designation of BYK 361N, BYK 353, and BYK 354 and so on. (BYK CHEMIE GMBH).

In the present process, the color ink composition comprises a colorant component in a fluid matrix. The colorant can be a dye, pigment, or a combination of pigments and dyes. The color ink chromophore is a metal, metal oxide, metal-organic, organometallic, or the alike, and in general is in a form of a dispersed pigment or dissolved metal-salt. The amount of colorant component in the ink composition in general is in the range of 1-50%, 5-50, 10-50, or 20-50% by weight. Examples of suitable pigments include, but are not limited to, those under the designation of Pigment Blue 1, Pigment Blue 15, Pigment Blue 15:1, Pigment Blue 15:2, Pigment Blue 15:3, Pigment Blue 15:4, Pigment Blue 15:6, Pigment Blue 27, Pigment Blue 27:1, Pigment Blue 28, Pigment Blue 30, Pigment Blue 31, Pigment Blue 32, Pigment Blue 33, Pigment Blue 34, Pigment Blue 35, Pigment Blue 36, Pigment Blue 36:1, Pigment Blue 62, Pigment Blue 71, Pigment Blue 72, Pigment Blue 73, Pigment Blue 74, and Pigment Blue 81, Pigment Brown 5, Pigment Brown 6, Pigment Brown 7, Pigment Brown 8, Pigment Brown 9, Pigment Brown 11, Pigment Brown 24, Pigment Brown 29, Pigment Brown 31, Pigment Brown 33, Pigment Brown 34, Pigment Brown 35, Pigment Brown 37, Pigment Brown 39, Pigment Brown 40, Pigment Brown 43, Pigment Brown 44, Pigment Brown 45, and Pigment Brown 46, Pigment Yellow 31, Pigment Yellow 32, Pigment yellow 33, Pigment Yellow 34, Pigment Yellow 34:1, Pigment Yellow 35, Pigment Yellow 35:1, Pigment Yellow 36, Pigment Yellow 36:1, Pigment Yellow 37, Pigment Yellow 37:1, Pigment Yellow 38, Pigment Yellow 39, Pigment Yellow 39, Pigment Yellow 40, Pigment Yellow 41, Pigment Yellow 42, Pigment Yellow 43, Pigment Yellow 44, Pigment Yellow 45, Pigment Yellow 46, Pigment Yellow 47, Pigment Yellow 53, Pigment Yellow 118, Pigment Yellow 119, Pigment Yellow 157, Pigment Yellow 158, Pigment Yellow 159, Pigment Yellow 160, Pigment Yellow 161, Pigment Yellow 162, Pigment Yellow 164, Pigment Yellow 184, Pigment Yellow 189, Pigment Yellow 219, and Pigment Yellow 227, Pigment Green 1, Pigment Green 2, Pigment Green 3, Pigment Green 7, Pigment Green 10, Pigment Green 14, Pigment Green 15, Pigment Green 16, Pigment Green 17, Pigment Green 18, Pigment Green 19, Pigment Green 20, Pigment Green 21, Pigment Green 22, Pigment Green, 23, Pigment Green 26, Pigment Green 39, Pigment Green 45, Pigment Green 48, Pigment Green 50, Pigment Green 51, and Pigment Green 56; Pigment Orange 20, Pigment Orange 20:1, Pigment Orange 21, Pigment Orange 21:1, Pigment Orange 23, Pigment Orange 23:1, Pigment Orange 45, Pigment Orange 75, and Pigment Orange 78; Pigment Red 39, Pigment Red 81:1, Pigment Red 81:2, Pigment Red 81:3, Pigment Red 101, Pigment Red 101:1, Pigment Red 102, Pigment Red 103, Pigment Red 104, Pigment Red 105, Pigment Red 106, Pigment Red 107, Pigment Red 108, Pigment Red 108:1, Pigment Red 109, Pigment Red 113, Pigment Red 113:1, Pigment Red 121, Pigment Red 169, Pigment Red 230, Pigment Red 231, Pigment Red 232, Pigment Red 233, Pigment Red 235, Pigment Red 236, Pigment Red 259, Pigment Red 265, and Pigment Red 275; Pigment Violet 1, Pigment Violet 1:1, Pigment Violet 2, Pigment Violet 2:2, Pigment Violet 3, Pigment Violet 14, Pigment Violet 15, Pigment Violet 16, Pigment Violet 47, Pigment Violet 48, and Pigment Violet 49; Pigment Black 11, Pigment Black 12, Pigment Black 13, Pigment Black 14, Pigment Black 17, Pigment Black 22, Pigment Black 23, Pigment Black 24, Pigment Black 25, Pigment Black 26, Pigment Black 27, Pigment Black 28, Pigment Black 29, Pigment Black 30, Pigment Black 33, Pigment Black 34, and Pigment Black 35; titanium dioxide (including rutile and anatase); zinc sulfide; and the like or a mixture thereof.

The color ink composition may comprise additives as those described above for a primer ink composition.

In one example of the present process, the primer ink composition comprises zinc acetate dissolved in an aqueous solvent matrix, and the color ink composition (red brown ink) comprises Fe/Cr/Zn-spinel pigment dispersed in fatty acid ester solvent matrix. The application of the primer ink composition to a substrate enhances the red brown color after the substrate is fired.

In one example of the present process, a first primer ink composition comprises titanium(IV) bis(ammonium lactato)dihydroxide dissolved in an aqueous solvent matrix, and a second primer ink composition comprises potassium antimony tartrate dissolved in an aqueous solvent matrix, and the color ink composition (green ink) comprises chromium(III) acetate hydroxide dissolved in an aqueous solvent matrix. The application of the primer ink compositions to a substrate shifts the chromium(III) green color to yellow after the substrate is fired.

Ceramic dye inks are more susceptible than pigmented inks to the elemental composition of the ceramic tile substrate. For example, typical yellow soluble salt dye inks are based on green solutions of Cr³⁺. Cr³⁺ is green in most ceramic environments, but in the presence of Sb⁺³ and TO⁺, both colorless metal ions, the color will undergo a dramatic shift to a reddish-yellow color after firing. In this case, Sb and Ti are the essential elements for producing yellow colors in a soluble salt ceramic process.

In another example of the present process, the primer ink composition comprises calcium lactate dissolved in an aqueous solvent matrix, and the color ink composition comprises tin chrome pink pigment dispersed in an aqueous solvent matrix. The application of the primer ink composition to a zinc-rich substrate increased the intensity of the pink color after the substrate is fired.

The invention is further illustrated by the following example.

### EXAMPLE

### Example 1. Process for Applying Digital Ceramic Primer Ink and Green Ink to Produce Yellow Color

The example outlines the steps of applying the digital ceramic primer with a green ink to generate a yellow color in a tile manufacturing process.

### Primer Ink Composition A

18% Potassium antimony tartrate—dissolved

<34% Water

16% Glycerine

31% Triethanol amine

1% Tartaric acid

<0.3% BYK 348

### Primer Ink Composition B

50% Titanium(IV) bis(ammonium lactate)dihydroxide—dissolved

<50% Water

<0.3 BYK 348

### Green Ink Composition

29% Chromium(III) acetate, basic—dissolved

16% Ammonium hydroxide, aqueous (35% solution)

11% Lactic acid

<44% Water

<0.3% BYK 348

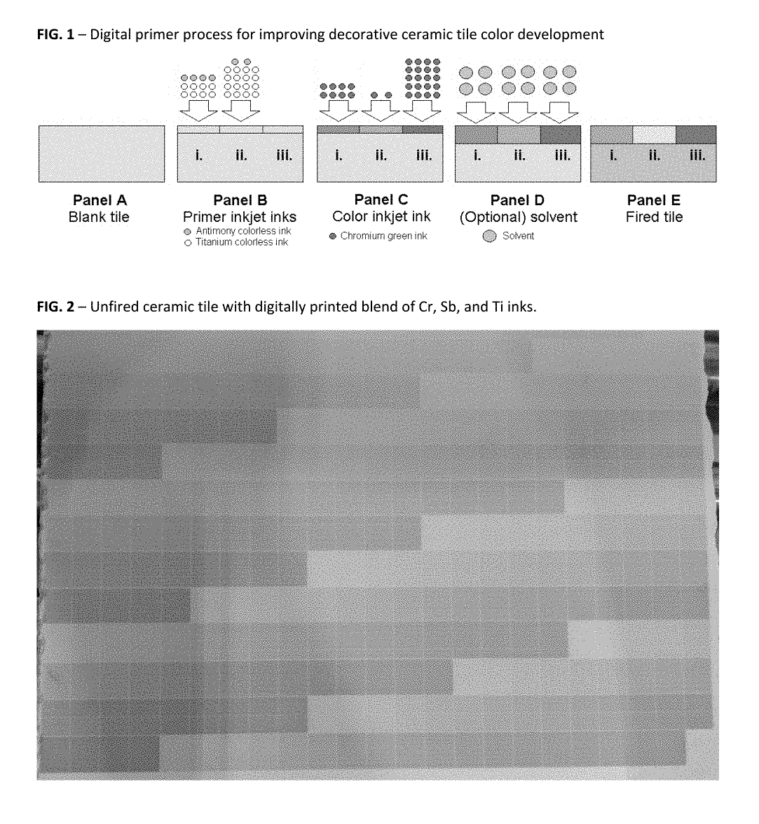

FIG. 1 shows the process of applying the primer inks and green color ink to a tile, and the results of the fired tile. Panel A represents a blank ceramic tile body, which often consists of unfired hydraulically pressed powders and binders. Other common ceramic tile substrates include pre-fired pressed tile bodies (bisque), glazed unfired tiles, glazed bisque tiles, and other similar substrates.

Panel B shows the ceramic tile primer inkjet inks being digitally printed before the colored ink (panel C), but this print order may be reversed in some applications. The printed images are derived from a digital design. The ability to change the printed pattern by simply loading a new digital image file into the printer is a key advantage of digital inkjet ink technology over traditional analog printing methods. The colorless primer inks may be printed only in the quantities and tile locations as required by the design. In this example, the tile is divided into three sections where the colorless antimony and titanium primer inks (panel B) and green chromium color ink (panel C) were applied in different molar ratios for each section. The ability to adjust the ratio of primer ink to color ink to optimize color development provides an advantage of digital inkjet over traditional analog printing methods. The elemental molar ratios applied to each tile section were (i) 11% Sb, 71% Ti, 18% Cr; (ii) 4% Sb, 95% Ti, 1% Cr; and (iii) 100% Cr.

Panel D demonstrates an optional step that is common for a soluble salt ceramic tile process. Solvent that is compatible with the primer ink components is applied to the tile surface by digital or analog methods (spray or waterfall techniques). This carries the soluble ink components into the tile body, which increases the depth within the tile that the digital image is visible in the final product after extensive surface wear due to use.

In panel E, the color benefits of the primer are visible only after the firing process.

FIG. 2 shows a real unfired tile that followed the steps as described in FIG. 1 using a sodium antimony tartrate (6.5% w/w Sb) primer ink, titanium(IV) bis(ammoniumlactato) dihydroxide (8% w/w Ti) primer ink, and chromium(III) acetate, basic (7.5% w/w Cr) green color ink. Since the elemental composition of a tile body will vary according to the raw materials used, the optimal primer ink quantities required to achieve a desired color shift must be evaluated experimentally. The three elemental blend ratios described in FIG. 1 were selected based on the measured color data from this tile after firing.

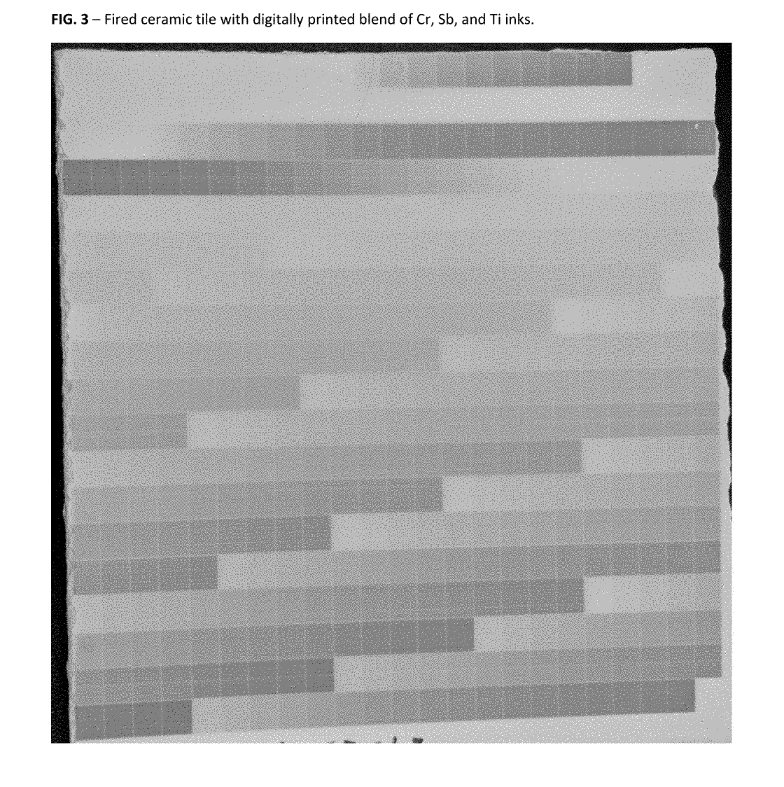

FIG. 3 shows the same tile from FIG. 2 after firing in a ceramic kiln for 1 hour at 1200° C. The colorless antimony and titanium primer inks causes a green chromium ink to undergo an obvious color shift to yellow. The fired color data for the three elemental blend ratios described in FIG. 1 (panel E) are shown in Table 1.

TABLE 1

| | Color Ink | | | | | |
|---|---|---|---|---|---|---|
| Fired | (Mol %) | Primer Inks (Mol %) | | | | |
| Color | Cr | Sb | Ti | L* | a* | b* |
| Green | 100% | 0% | 0% | 61.65 | −5.05 | 18.95 |
| Yellow | 1% | 4% | 95% | 88.40 | 1.26 | 28.54 |
| Reddish- | 18% | 11% | 71% | 82.29 | 7.04 | 43.12 |
| Yellow | | | | | | |

It is to be understood that the foregoing describes preferred embodiments of the present invention and that modifications may be made therein without departing from the scope of the present invention as set forth in the claims.

What is claimed is:

1. A process for preparing a decorative fired substrate, comprising the steps of:
(a) digitally applying a primer ink composition on the surface of one or more selected locations of a substrate by a first digital inkjet printer to form a primer layer on the selected locations, wherein the primer composition comprises a colorless metal or metalloid ion component dissolved in a first liquid matrix,
(b) digitally applying a color ink composition on the selected locations by a second digital inkjet printer or printbar, wherein the color ink composition comprises color pigments or dyes dispersed or dissolved in a second liquid matrix, and then
(c) firing the substrate in a high temperature kiln.

2. The process of claim 1, further comprising applying one or more glaze layers on the substrate before firing the substrate.

3. The process of claim 1, wherein the substrate is made of ceramic, glass, brick, metal, or metal enamel.

4. The process of claim 1, wherein the metal or a metalloid ion is selected from the group of ions consisting of: aluminum, antimony, barium, bismuth, boron, calcium, lithium, magnesium, potassium, sodium, strontium, tin, titanium, tungsten, zinc, zirconium, gallium, germanium, indium, manganese, cadmium, selenium, lanthanum, cerium, praseodymium, neodymium, samarium, europium, gadolinium, terbium, holmium, erbium, thulium, ytterbium, lutetium, and any combination thereof.

5. The process of claim 1, wherein the metal or a metalloid ion is antimony or titanium.

6. The process of claim 5, wherein the metal or metalloid ion component is present in the form of an acetate, alkoxide, alkyl, amide, amidinate, antimonate, azide, β-diketonate, borate, carbamate, carbonyl, carboxylate, cyanide, cyclopentadienide, guanidate, hydroxide, imidazolate, lactate, manganate, nitrate, nitride, oxide, phosphate, phosphite, phosphonate, pyrazolate, selenate, silicate, stannate, sulfate, tartrate, thiocarboxylate, dithiocarboxylate, thiolate, titanate, or tungstate, or any combination thereof.

7. The process of claim 6, wherein the metal ion component is zinc acetate, calcium lactate, titanium(IV) bis(ammonium lactato) dihydroxide, potassium antimony tartrate or sodium antimony tartrate.

8. The process of claim 1, wherein the metal or metalloid ion component is 0.1-70% w/w of the primer ink composition.

9. The process of claim 8, wherein the metal or metalloid ion component is 10-60% w/w of the primer ink composition.

10. The process of claim 1, wherein the primer composition further comprises 0.01-50% (w/w) of one or more additive materials selected from the group consisting of: anti-setting agents, surfactants, pH buffer, leveling agents, and defoaming agents.

11. The process of claim 1, wherein the liquid matrix comprises one or more aqueous solvents or organic solvents.

12. The process of claim 1, wherein the primer ink composition comprises titanium(IV) bis(ammonium lactato)dihydroxide dissolved in an aqueous solvent matrix, and the color ink composition comprises chromium(III) acetate, basic in an aqueous solvent matrix.

13. The process of claim 12, comprising applying an additional primer ink composition comprising sodium antimony tartrate or potassium antimony tartrate dissolved in an aqueous solvent matrix.

14. The process of claim 1, wherein the primer composition comprises calcium ions and water, and the color ink composition comprises tin chrome pink pigment dispersed in a aqueous solvent matrix.

15. The process of claim 1, wherein step (a) is applied before step (b).

16. The process of claim 1, wherein step (b) is applied before step (a).
